(19) United States
(12) Patent Application Publication
(10) Pub. No.: US 2026/0087532 A1
(43) Pub. Date: Mar. 26, 2026

(54) MANAGEMENT SYSTEM

(71) Applicant: TOYOTA JIDOSHA KABUSHIKI KAISHA, Toyota-shi (JP)

(72) Inventor: Kohei DOBASHI, Toyota-shi (JP)

(73) Assignee: TOYOTA JIDOSHA KABUSHIKI KAISHA, Toyota-shi (JP)

(21) Appl. No.: 19/203,524

(22) Filed: May 9, 2025

(30) Foreign Application Priority Data
Sep. 25, 2024 (JP) 2024-166371

(51) Int. Cl. G06Q 30/0283; G06F 9/451

(52) U.S. Cl. CPC G06Q 30/0283; G06F 9/451

(57) ABSTRACT

The management system includes a communication terminal, a charger driven based on charger information, and an application server that stores total charger information. The communication terminal includes a display unit that displays the total charger information acquired from the application server. The total charger information includes charger correspondence information corresponding to the charger information. The charger information is updated at an update timing that is a timing when the application server updates the charger correspondence information.

### CROSS-REFERENCE TO RELATED APPLICATION

This application claims priority to Japanese Patent Application No. 2024-166371 filed on Sep. 25, 2024. The disclosure of the above-identified application, including the specification, drawings, and claims, is incorporated by reference herein in its entirety.

### BACKGROUND

### 1. Technical Field

The present disclosure relates to a management system.

### 2. Description of Related Art

Japanese Unexamined Patent Application Publication No. 2023-105425 (JP 2023-105425 A) discloses a service providing system in which the number of maintenance vehicles can be equalized. Specifically, in the service providing system, when an abnormality of a vehicle occurs, the vehicle requests a server of a dealer to propose a maintenance schedule via a server of a vehicle manufacturer. The vehicle displays a data table (information on maintenance date and time candidates including information on maintenance fees and the like at a predetermined date and time) proposed from the server of the dealer on an information terminal of the user. The user of the vehicle selects a desired maintenance date and time from the data table. The selected maintenance date and time is transmitted to the server of the dealer, and the maintenance date and time is confirmed. The information on the maintenance fee and the like included in the data table is changed based on the reservation status and is updated at a predetermined cycle.

### SUMMARY

The present inventor has examined a management system that provides total charger information to a charger user based on JP 2023-105425 A. The total charger information refers to information in which the charger information (information including a power unit price, business hours, and the like) of a plurality of chargers is integrated. The total charger information is configured by charger correspondence information corresponding to charger information that each of the chargers has. A user of an electrified vehicle views the total charger information displayed on the user's mobile terminal or the like through the application to decide the charger that charges the electrified vehicle. Thereafter, the user of the electrified vehicle charges the electrified vehicle using the decided charger based on the power unit price requested by the charger or the like.

Here, when the manager of the charger in the management system changes the charger information, the manager inputs the change information to the information input terminal. The change information is transmitted from the information input terminal to the charger and the application server. The charger updates the change information to the charger information stored in the charger at a predetermined update timing. The application server updates the change information to the total charger information stored in the application server at a predetermined update timing.

In such a system, when the update timing of the charger and the update timing of the application server are different from each other, a situation may occur in which the charger information acquired by the application server and the charger information stored in the charger are different from each other.

The present disclosure has been made to solve the above-described problems, an object of the present disclosure is to provide a management system that suppresses a difference in content between charger information stored in a charger and charger correspondence information stored in an application server.

A management system according to a first aspect of the present disclosure includes
a communication terminal, a charger configured to operate based on charger information, and an application server configured to store total charger information,
in which the communication terminal includes a display unit configured to display the total charger information acquired from the application server,
the total charger information includes charger correspondence information corresponding to the charger information, and
the charger information is updated at an update timing that is a timing when the application server updates the charger correspondence information.

With the management system according to the first aspect of the present disclosure,
the charger stores the charger information, and
the charger updates the charger information at the update timing.

The management system according to the first aspect of the present disclosure further includes
a management server configured to manage the charger,
in which the management server transmits change information that is a part of the charger information to the charger at the update timing, and
the charger stores the charger information and updates the charger information based on the change information.

The management system according to the first aspect of the present disclosure further includes
an information input terminal, and a management server configured to manage the charger, in which the information input terminal transmits change information that is a part of the charger information to the management server at the update timing,
the management server transmits the change information to the charger, and
the charger stores the charger information and updates the charger information based on the change information.

The management system according to the first aspect of the present disclosure further includes
an information input terminal, a management server configured to manage the charger, and a manager terminal used by a manager of the management server,
in which the manager terminal notifies the manager of the update timing,
the information input terminal transmits, to the management server, change information that is a part of the charger information and is input by the manager to the information input terminal,
the management server transmits the change information to the charger, and
the charger stores the charger information and updates the charger information based on the change information.

With the management system according to the present disclosure, it is possible to suppress the difference in content between the charger information stored in the charger and the charger correspondence information stored in the application server.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a management system according to the present embodiment;

FIG. 2 is a diagram showing an outline of first charger information and change information of the present embodiment;

FIG. 3 is a diagram showing an outline of the total charger information, the first charger correspondence information, and the change information of the present embodiment;

FIG. 4 is a control flowchart of a management system according to the present embodiment;

FIG. 5 is a continuation of a control flowchart of the management system according to the present embodiment;

FIG. 6 is a control flow of a management system according to Modification Example 1 of the present embodiment;

FIG. 7 is a control flow of a management system according to Modification Example 2 of the present embodiment; and

FIG. 8 is a control flow of a management system according to Modification Example 3 of the present embodiment.

### DETAILED DESCRIPTION OF EMBODIMENTS

### Entire Configuration of Management System

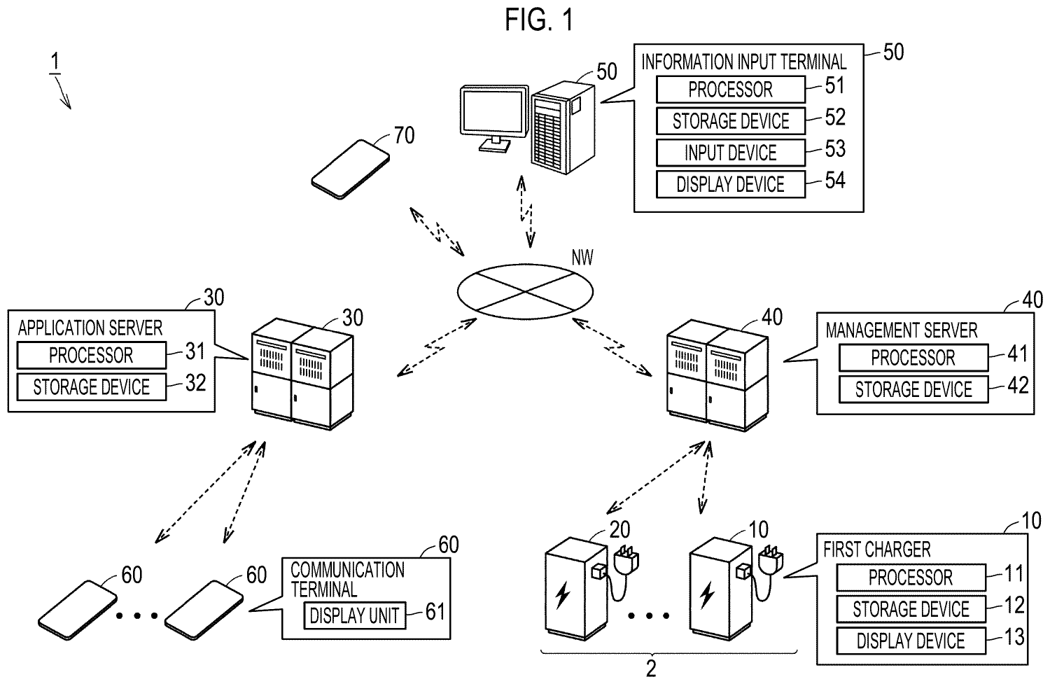

Hereinafter, an embodiment of the present disclosure will be described in detail with reference to the drawings. In the drawings, the same or corresponding parts are denoted by the same reference numerals, and the description thereof will not be repeated. FIG. 1 is a diagram showing a schematic configuration of a management system according to the present embodiment.

The management system 1 includes a plurality of chargers 2, an application server 30, a management server 40, an information input terminal 50, a communication terminal 60, and a manager terminal 70. The application server 30, the management server 40, the information input terminal 50, and the manager terminal 70 are connected to be able to communicate in both directions through the network NW. The chargers 2 and the management server 40 are connected to be able to communicate in both directions. The application server 30 and the communication terminal 60 are connected to each other such that communication can be performed in both directions.

The chargers 2 include a first charger 10 and a second charger 20. Since the first charger 10 and the second charger 20 have substantially the same configuration, the first charger 10 will be described below.

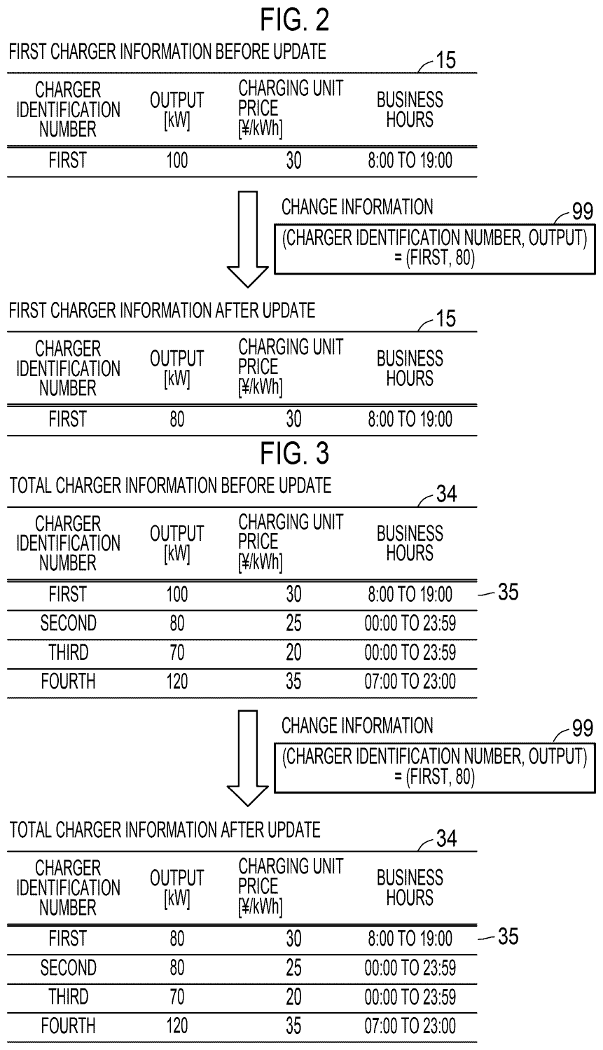

The first charger 10 includes a processor 11, a storage device 12, and a display device 13. The processor 11 includes, for example, a central processing unit (CPU). The storage device 12 is a volatile memory, such as a random access memory (RAM). The display device 13 is a display such as an organic electroluminescence (EL) or a liquid crystal. The display (not shown) is configured to display various pieces of information in response to a control command from the processor 11. With reference to FIG. 2, the storage device 12 stores first charger information 15, the change information 99, and update timing information (not shown). The first charger information 15 is information such as an identification number of the first charger 10, output, a charging unit price, and business hours. The change information 99 includes a part of the information of the charger information excluding the charger identification number, together with the charger identification number. In the embodiment of the present disclosure, the change information 99 is information related to the output of the first charger information 15. The update timing information is information on the timing at which the application server 30 updates the total charger information 34 to be described later. Referring to FIG. 1 again, the first charger 10 is driven based on the first charger information 15. The processor 11 updates the first charger information 15 with the change information 99 at the update timing based on the update timing information.

The application server 30 includes a processor 31 and a storage device 32. The processor 31 includes, for example, a central processing unit (CPU). The storage device 32 is a volatile memory, such as a random access memory (RAM). With reference to FIG. 3, the storage device 32 stores the total charger information 34, the change information 99, and update timing information (not shown). The total charger information 34 is a data table in which the charger information of each of the chargers 2 is centrally managed. The total charger information 34 includes, for example, first charger correspondence information 35 corresponding to the first charger information 15 shown in FIG. 2. The first charger correspondence information 35 is information on output, a charging unit price, business hours, and the like related to the first charger. That is, the first charger correspondence information 35 is substantially the same as the first charger information 15. The update timing information is information on update timing at which the application server 30 updates the total charger information 34 with the change information 99. Specifically, the update timing may be any periodic date and time or may be a timing at which a predetermined number of accesses is made to the application server 30. With reference to FIG. 1 again, the processor 31 updates the total charger information 34 with the change information 99 at the update timing based on the update timing information. In the embodiment of the present disclosure, the processor 31 of the application server 30 determines that the change information 99 is the information related to the first charger 10. Based on the determination, the application server 30 updates the first charger correspondence information 35 in the total charger information 34 to the content of the change information 99.

The management server 40 includes a processor 41 and a storage device 42. The processor 41 includes, for example, a central processing unit (CPU). The storage device 12 is a volatile memory, such as a random access memory (RAM). The storage device stores update timing information and change information 99 shown in FIG. 2. The management server 40 acquires the change information 99 from the information input terminal 50. The processor 41 determines that the change information 99 is information related to the first charger information 15, for example, based on the data of the change information 99. The management server 40 transmits the change information 99 to the first charger 10.

The information input terminal 50 includes a processor 51, a storage device 52, an input device 53, and a display device 54. The processor 51 includes, for example, a central processing unit (CPU). The storage device 52 is a volatile memory, such as a random access memory (RAM). The input device 53 receives a signal generated by an operation of the manager of the management server 40. The manager of the management server 40 can input a predetermined instruction or request to the input device 53. As the input device 53, a touch panel, or various switches, various pointing devices, a keyboard, or the like may be used in addition to or in place of the touch panel. The display device 54 is, for example, a display, and outputs various pieces of information (processing results and the like) to the operator. In the embodiment of the present disclosure, the manager of the management server 40 inputs the change information 99 to the information input terminal 50 through the input device 53. The change information 99 is stored in the storage device 52. The information input terminal 50 transmits the change information 99 to the application server 30 and the management server 40.

The communication terminal 60 is, for example, a terminal owned by a user of an electrified vehicle that can be charged by the first charger 10. The communication terminal 60 has a display unit 61. The communication terminal 60 has application software that can communicate with the application server 30. The user of the electrified vehicle acquires the total charger information 34 stored in the application server 30 via the communication terminal 60. The total charger information 34 is displayed on a display unit of the communication terminal 60. A user of the electrified vehicle selects a charger to be used from the chargers 2 or the like based on the total charger information 34 displayed on the display unit of the communication terminal 60.

### Control Flow of Management System

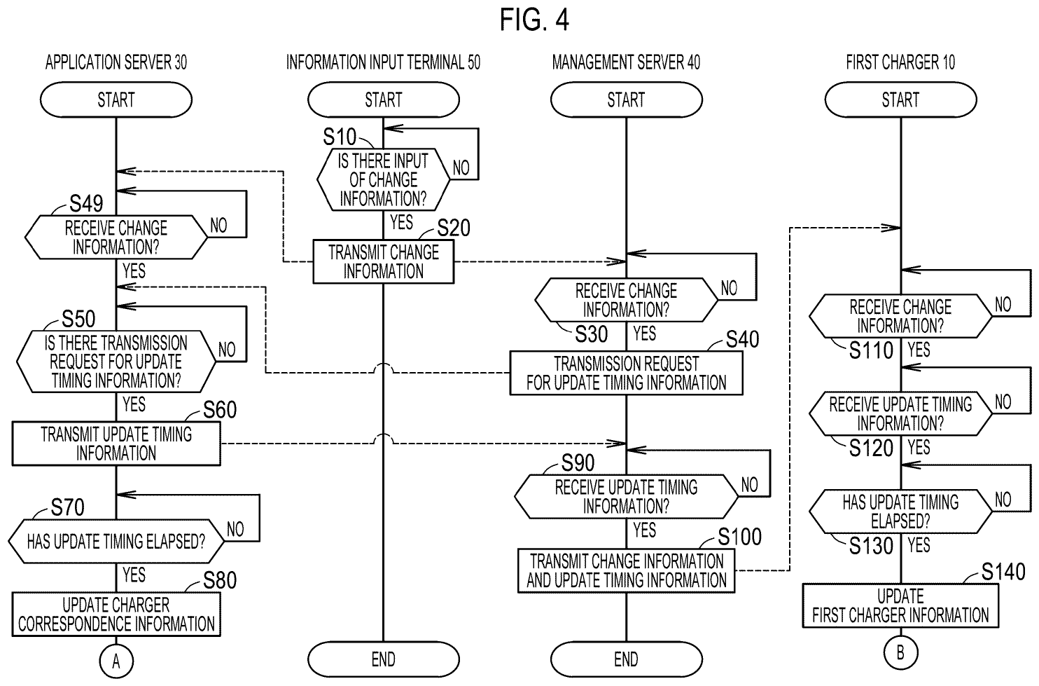

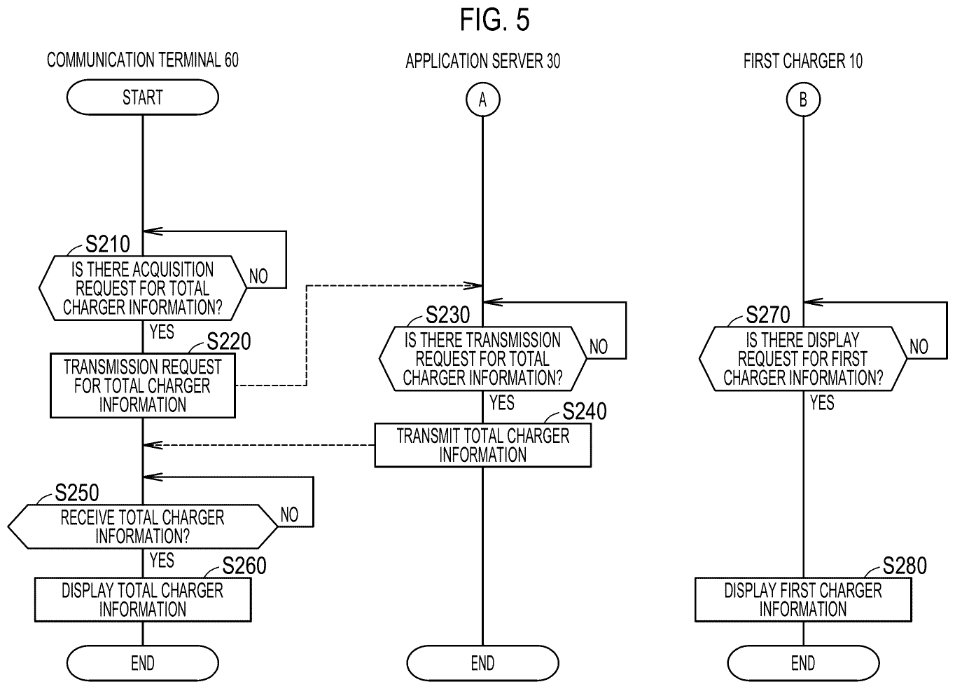

The manager terminal 70 is, for example, a terminal owned by a manager of the management server 40. The manager terminal 70 includes a display screen and a speaker (not shown). The manager terminal 70 is configured to notify the manager of the management server 40 of the update timing based on the update timing information. The information input terminal 50 may include a function of the manager terminal 70. Next, a control flow of the management system executed by the management system will be described with reference to FIGS. 4 and 5.

In S10 shown in FIG. 4, the information input terminal 50 confirms whether the change information 99 is input. The input of the change information 99 is made by the manager of the management server 40 inputting the content of the change information 99 through the input device 53 of the information input terminal 50. In the embodiment of the present disclosure, an example in which the manager of the management server 40 inputs the content of the change information 99 shown in FIG. 2 is shown. When the change information 99 is input (Yes in S10), the information input terminal 50 stores the change information 99 in the storage device 52, and the process of the information input terminal 50 proceeds to S20. When there is no input of the change information 99 (No in S10), the information input terminal 50 executes S10 again.

In S20, the information input terminal 50 transmits the change information 99 to the application server 30 and the management server 40. Thereafter, the information input terminal 50 ends the process of the management system 1.

In S30, the management server 40 confirms whether change information 99 is received. When the change information 99 is received (Yes in S30), the management server 40 stores the change information 99 in the storage device 42, and the processing of the management server 40 proceeds to S40. When the change information 99 is not received (No in S30), the management server 40 processes S30 again.

In S40, the management server 40 requests the application server 30 to transmit the update timing information. Thereafter, the process of the management server 40 proceeds to S90.

In S49, the application server 30 confirms whether that the change information 99 is received. When the change information 99 is received (Yes in S49), the change information 99 is stored in the storage device 32 of the application server 30, and the process of the application server 30 proceeds to S50. When the change information 99 is not received (No in S49), the application server 30 processes S49 again.

In S50, the application server 30 checks whether there is a transmission request for the update timing information. When there is a transmission request for update timing information (Yes in S50), the process of the application server 30 proceeds to S60. When there is no update timing information transmission request (No in S50), the application server 30 processes S50 again.

In S60, the application server 30 transmits the update timing information to the management server 40. Thereafter, the processing of the application server 30 proceeds to S70.

In S70, the application server 30 checks whether the update timing based on the update timing information has elapsed. When the update timing has elapsed (Yes in S70), the processing of the application server 30 proceeds to S80. When the update timing has not elapsed (No in S70), the application server 30 processes S70 again.

In S80, the application server 30 updates the first charger correspondence information 35. More specifically, the application server 30 stores the change information 99 in the storage device 32 in S49. When the update timing elapses, the processor 31 of the application server 30 updates the total charger information 34 based on the change information 99 stored in the storage device 32. More specifically, in the embodiment of the present disclosure, the change information 99 is information about the first charger 10. Therefore, the processor 31 updates the first charger correspondence information 35 in the total charger information 34 to the content of the change information 99. As a result, the content of the first charger correspondence information 35 is the content of the updated first charger correspondence information 35 shown in FIG. 3. Thereafter, the processing of the application server 30 proceeds to S230.

In S90, the management server 40 confirms whether the update timing information is received. When the update timing information is received (Yes in S90), the management server 40 stores the update timing information in the storage device 42, and the processing of the management server 40 proceeds to S100. When the update timing information is not received (No in S90), the management server 40 processes S90 again.

In S100, the management server 40 transmits the change information 99 and the update timing information to the first charger 10. More specifically, in the embodiment of the present disclosure, the processor 41 of the management server 40 determines that the change information 99 is the information related to the first charger 10. Based on the determination, the management server 40 transmits the change information 99 and the update timing information to the first charger 10. Thereafter, the management server 40 ends the process of the management system 1.

In S110, the first charger 10 confirms whether the change information 99 is received. When the change information 99 is received (Yes in S110), the first charger 10 stores the change information 99 in the storage device 12, and the process of the first charger 10 proceeds to S120. When the change information 99 is not received (No in S110), the first charger 10 processes S110 again.

In S120, the first charger 10 confirms whether the update timing information is received. When the update timing information is received (Yes in S120), the first charger 10 stores the update timing information in the storage device 12, and the process of the first charger 10 proceeds to S130. When the update timing information is not received (No in S120), the first charger 10 processes S120 again.

In S130, the first charger 10 confirms whether the update timing based on the update timing information has elapsed. When the update timing has elapsed (Yes in S130), the process of the first charger 10 proceeds to S140. When the update timing has not elapsed (No in S130), the first charger 10 processes S130 again.

In S140, the first charger 10 updates the first charger information 15. More specifically, when the update timing elapses, the processor 11 of the first charger 10 updates the first charger information 15 stored in the storage device 12 based on the change information 99 stored in the storage device 12. As a result, the content of the first charger information 15 becomes the content of the updated first charger information 15 shown in FIG. 2. Thereafter, the process of the first charger 10 proceeds to S270.

With reference to FIG. 5, in S210, the communication terminal 60 confirms whether there is a request for acquiring the total charger information 34. Here, the acquisition request for the total charger information 34 is made, for example, by the user of the communication terminal 60 activating the application software for acquiring the total charger information 34 installed in the communication terminal 60. Alternatively, the user of the communication terminal 60 may access a website for viewing the total charger information 34. When there is the acquisition request of the total charger information 34 (Yes in S210), the processing of the communication terminal 60 proceeds to S220. When there is no acquisition request for the total charger information 34 (No in S210), the communication terminal 60 processes S210 again.

In S220, the communication terminal 60 requests the application server 30 to transmit the total charger information 34. Thereafter, the processing of the communication terminal 60 proceeds to S250.

In S230, the application server 30 checks whether there is a transmission request for the total charger information 34. When there is the transmission request of the total charger information 34 (Yes in S230), the processing of the application server 30 proceeds to S240. When there is no transmission request of the total charger information 34 (No in S230), the application server 30 processes S230 again.

In S240, the application server 30 transmits the total charger information 34 to the communication terminal 60. Thereafter, the application server 30 ends the process of the management system 1.

In S250, the communication terminal 60 confirms whether the total charger information 34 is received. When the total charger information 34 is received (Yes in S250), the process of the communication terminal 60 proceeds to S260. When the total charger information 34 is not received (No in S250), the communication terminal 60 processes S250 again.

In S260, the communication terminal 60 displays the total charger information 34 on the display unit 61 of the communication terminal 60. Thereafter, the communication terminal 60 ends the process of the management system 1.

In S270, the first charger 10 confirms whether there is a request to display the first charger information 15. Here, the display request of the first charger information 15 is made, for example, by a user who uses the first charger 10 touching the display device 13 of the first charger 10. The user of the first charger 10 confirms the first charger information 15 displayed on the display device 13 before charging the electrified vehicle using the first charger 10, and determines whether to use the first charger 10. When there is a display request for the first charger information 15 (Yes in S270), the process of the first charger 10 proceeds to S280. When there is no display request of the first charger information 15 (No in S270), the first charger 10 processes S270 again.

In S280, the first charger 10 displays the first charger information 15 on the display device 13. Thereafter, the first charger 10 ends the process of the management system 1.

In the above-described embodiment, the application server 30 updates the first charger correspondence information 35 with the change information 99 at the update timing based on the update timing information. The first charger 10 updates the first charger information 15 with the change information 99 at the update timing based on the update timing information acquired from the application server 30. As a result, the content of the change information 99 is updated to the first charger information 15 and the first charger correspondence information 35 at the same timing. As a result, it is possible to suppress the difference in content between the first charger information 15 stored in the first charger 10 and the first charger correspondence information 35 stored in the application server 30.

### Modification Example 1

The “same timing” in the present disclosure includes a case where the date and time are completely matched and a case where the date and time are substantially the same. That is, in the present disclosure, substantially the same means that a slight error due to the processing speed of the processor or the processing path until the update of the change information 99 after the update timing is included.

In the embodiment of the present disclosure, an example has been described in which the first charger 10 reserves the flow progress of the management system 1 until the update timing, but the present disclosure is not limited thereto. For example, the management server 40 may manage the flow of the management system 1 until the update timing.

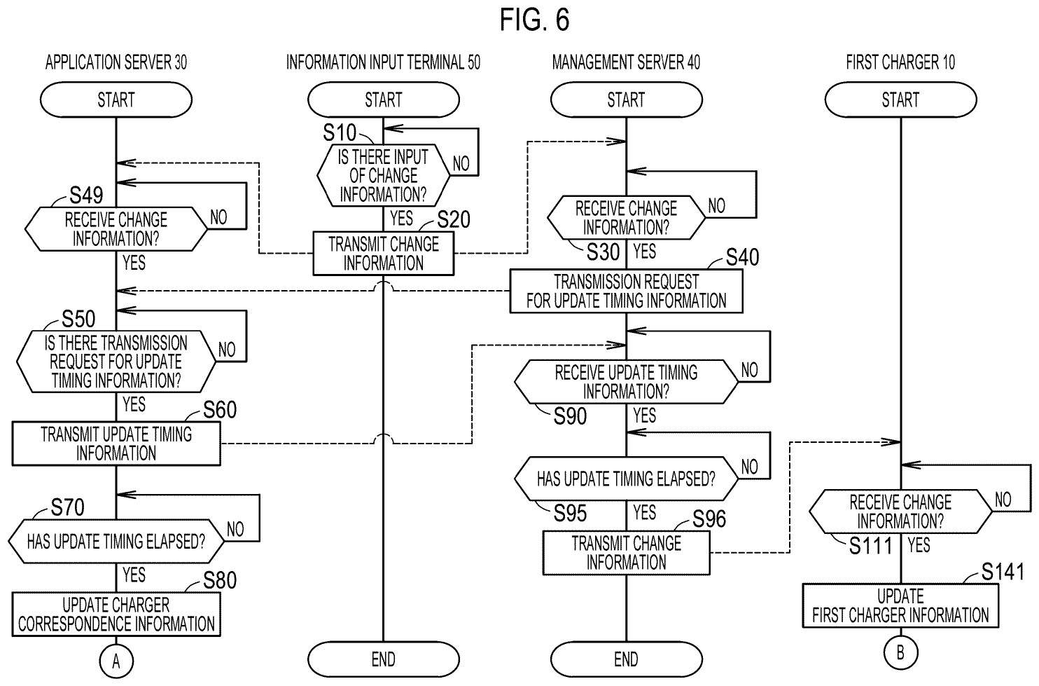

FIG. 6 shows a control flow of the management system 1 according to Modification Example 1 of the embodiment. Since each of the processes from S10 to S90 is the same as each of the processes from S10 to S90 described in FIG. 4, the description thereof will be omitted.

In S95, the management server 40 checks whether the update timing based on the update timing information has elapsed. When the update timing has elapsed (Yes in S95), the process of the management server 40 proceeds to S96. When the update timing has not elapsed (No in S95), the management server 40 processes S95 again.

In S96, the management server 40 transmits the change information 99 to the first charger 10. More specifically, the processor 41 of the management server 40 determines that the change information 99 is the information related to the first charger 10. Based on the determination, the management server 40 transmits the change information 99 to the first charger 10. Thereafter, the management server 40 ends the process of the management system 1.

In S111, the first charger 10 confirms whether the change information 99 is received. When the change information 99 is received (Yes in S111), the first charger 10 stores the change information 99 in the storage device 12, and the process of the first charger 10 proceeds to S141. When the change information 99 is not received (No in S111), the first charger 10 processes S111 again.

In S141, the first charger 10 updates the first charger information 15. More specifically, the processor 11 of the first charger 10 immediately updates the first charger information 15 based on the change information 99 in S141 when determination is made that the change information 99 is received in S111. Thereafter, the process of the first charger 10 proceeds to S270.

Here, since the processing after S80 in the second charger 20 and the processing after S141 in the first charger 10 follow the above-described FIG. 5, the description thereof will be omitted.

### Modification Example 2

In the above-described embodiment, the application server 30 updates the first charger correspondence information 35 with the change information 99 at the update timing based on the update timing information. The management server 40 transmits the change information 99 to the first charger 10 at the update timing based on the update timing information acquired from the application server 30. The first charger 10 immediately updates the first charger information 15 with the change information 99 after receiving the change information 99. As a result, the content of the change information 99 is updated to the first charger information 15 and the first charger correspondence information 35 at the same timing. As a result, it is possible to suppress the difference in content between the first charger information 15 stored in the first charger 10 and the first charger correspondence information 35 stored in the application server 30.

In the embodiment of the present disclosure, the information input terminal 50 may further hold the flow of the management system 1 until the update timing.

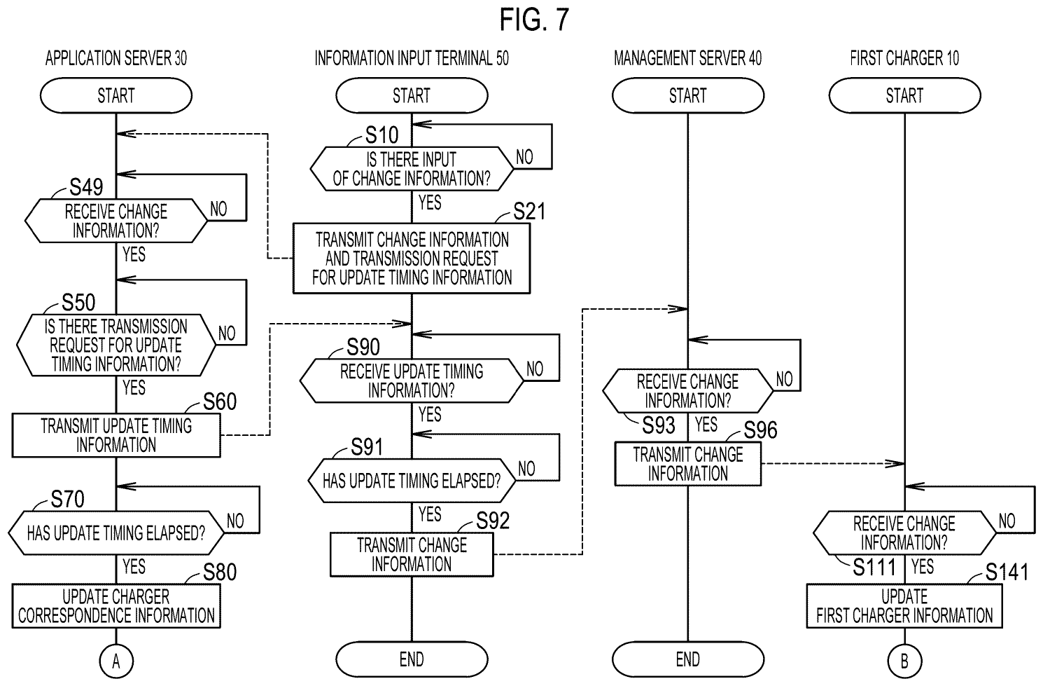

FIG. 7 shows a control flow of the management system 1 according to Modification Example 2 of the embodiment. Since the process of S10 is the same as S10 of FIG. 4 described above, the description thereof will be omitted.

In S21, the information input terminal 50 transmits the change information 99 to the application server 30 and requests the application server 30 to transmit the update timing information. Thereafter, the process of the information input terminal 50 proceeds to S90.

Since each of the processes from S49 to S90 is the same as each of the processes from S49 to S90 described in FIG. 4, the description thereof will be omitted.

In S91, the information input terminal 50 checks whether the update timing based on the update timing information has elapsed. When the update timing has elapsed (Yes in S91), the processing of the information input terminal 50 proceeds to S92. When the update timing has not elapsed (No in S91), the information input terminal 50 processes S91 again.

In S92, the information input terminal 50 transmits the change information 99 to the management server 40. Thereafter, the information input terminal 50 ends the process of the management system 1.

In S93, the management server 40 confirms whether the change information 99 is received. When the change information 99 is received (Yes in S93), the management server 40 stores the change information 99 in the storage device 42, and the processing of the management server 40 proceeds to S96. When the change information 99 is not received (No in S93), the management server 40 processes S93 again.

In S96, the management server 40 transmits the change information 99 to the first charger 10. More specifically, the processor 41 of the management server 40 determines that the change information 99 is the information related to the first charger 10. Based on the determination, the management server 40 transmits the change information 99 to the first charger 10. Thereafter, the management server 40 ends the process of the management system 1.

After S96, the first charger 10 executes S111 and S141. Since the processing of S111 and S141 of the first charger 10 is the same as the processing of S111 and S141 of FIG. 6 described above, the description thereof will be omitted. Further, since the processing after S80 in the application server 30 and the processing after S141 in the first charger 10 follow the above-described FIG. 5, the description thereof will be omitted.

### Modification Example 3

In the above-described embodiment, the application server 30 updates the first charger correspondence information 35 with the change information 99 at the update timing based on the update timing information. The information input terminal 50 transmits the change information 99 to the management server 40 at the update timing based on the update timing information acquired from the application server 30. The management server 40 immediately transmits the change information 99 to the first charger 10 after receiving the change information 99. The first charger 10 immediately updates the first charger information 15 with the change information 99 after receiving the change information 99. As a result, the content of the change information 99 is updated to the first charger information 15 and the first charger correspondence information 35 at the same timing. As a result, it is possible to suppress the difference in content between the first charger information 15 stored in the first charger 10 and the first charger correspondence information 35 stored in the application server 30.

In the embodiment of the present disclosure, the manager of the management server 40 may be further requested to reserve the input of the change information 99 to the information input terminal 50 until the update timing. More specifically, the management server 40 is configured to notify the manager of the management server 40 of the update timing by the manager terminal 70, and the manager of the management server 40 is configured to hold the input of the change information 99 until immediately before the update timing.

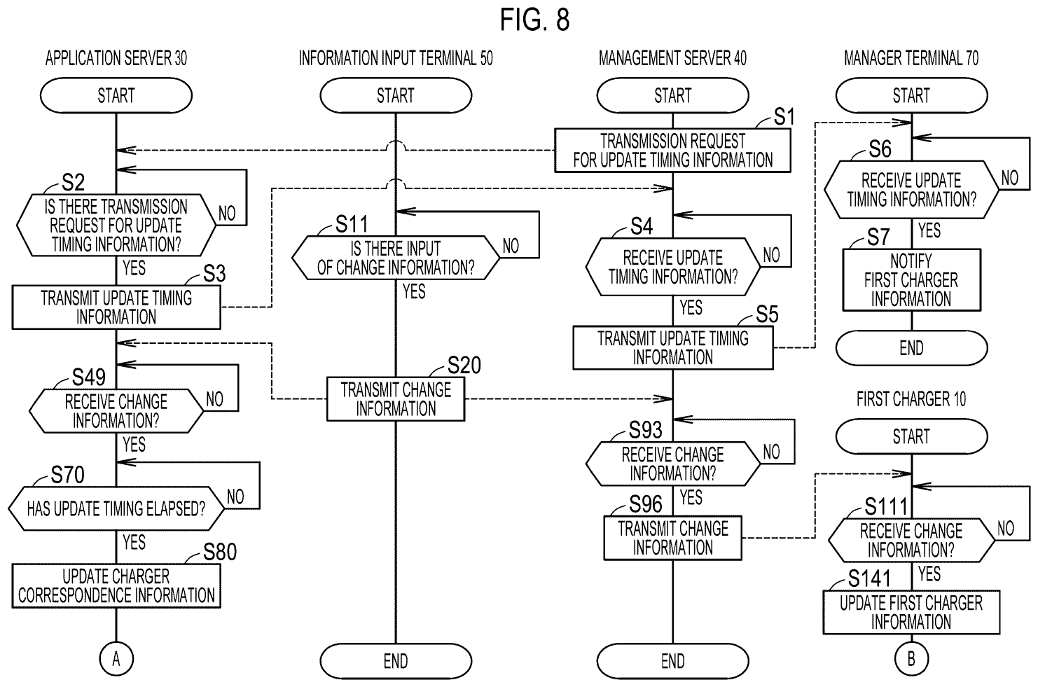

FIG. 8 shows a control flow of the management system 1 according to Modification Example 3. In S1, the management server 40 requests the application server 30 to transmit the update timing information. Thereafter, the process of the management server 40 proceeds to S4.

In S2, the application server 30 confirms whether there is a transmission request for the update timing information. When there is a transmission request for the update timing information (Yes in S2), the processing of the application server 30 proceeds to S3. When there is no transmission request of the update timing information (No in S2), the application server 30 processes S2 again.

In S3, the application server 30 transmits the update timing information to the management server 40. Thereafter, the processing of the application server 30 proceeds to S70.

In S4, the management server 40 confirms whether the update timing information is received. When the update timing information is received (Yes in S4), the management server 40 stores the update timing information in the storage device 42, and the processing of the management server 40 proceeds to S5. When the update timing information is not received (No in S4), the management server 40 processes S4 again.

In S5, the management server 40 transmits the update timing information to the manager terminal 70. Thereafter, the process of the management server 40 proceeds to S93.

In S6, the manager terminal 70 confirms whether the update timing information is received. When the update timing information is received (Yes in S6), the process of the manager terminal 70 progresses to S7. When the update timing information is not received (No in S6), the manager terminal 70 processes S6 again.

In S7, the manager terminal 70 notifies the manager of the management server 40 having the manager terminal 70 of the update timing based on the update timing information. The update timing notification is performed before the update timing. The manager of the management server 40 adjusts the timing for inputting the change information 99 to the information input terminal 50 based on the update timing notified from the manager terminal 70.

In S11, the information input terminal 50 checks whether the change information 99 is present. When there is an input of the change information 99 (Yes in S11), the process of the information input terminal 50 proceeds to S20. When there is no input of the change information 99 (No in S11), the information input terminal 50 processes S11 again.

In S20, the information input terminal 50 transmits the change information 99 to the application server 30 and the management server 40. Thereafter, the information input terminal 50 ends the process of the management system 1.

In S49, the application server 30 confirms whether the change information 99 is received. When the change information 99 is received (Yes in S49), the change information 99 is stored in the storage device 32 of the application server 30, and the process of the application server 30 proceeds to S70. When the change information 99 is not received (No in S49), the application server 30 processes S49 again.

After S49, the application server 30 executes S70 and S80. The processing of S70 and S80 of the application server 30 is the same as the processing of S70 and S80 of FIG. 4 described above, and thus the description thereof will be omitted.

Since each of the processes of S93 to S141 is the same as each of the processes of S93 to S141 described in FIG. 7, the description thereof will be omitted. Further, since the processing after S80 in the application server 30 and the processing after S141 in the first charger 10 follow the above-described FIG. 5, the description thereof will be omitted.

In the above-described embodiment, the manager terminal 70 notifies the manager of the management server 40 of the update timing based on the update timing information. The manager of the management server 40 inputs the change information 99 to the information input terminal 50 based on the update timing. The information input terminal 50 transmits the change information 99 to the application server 30 and the management server 40 immediately after the change information 99 is input. The application server 30 updates the first charger correspondence information 35 with the change information 99 at the update timing based on the update timing information. The management server 40 immediately transmits the change information 99 to the first charger 10 after receiving the change information 99. The first charger 10 immediately updates the first charger information 15 with the change information 99 after receiving the change information 99. When the manager of the management server 40 inputs the change information 99 to the information input terminal 50 immediately before the update timing, the contents of the change information 99 are updated to the first charger information 15 and the first charger correspondence information 35 at the same timing. As a result, it is possible to suppress the difference in content between the first charger information 15 stored in the first charger 10 and the first charger correspondence information 35 stored in the application server 30.

The management server 40 may include a function of the manager terminal 70, and the management server 40 may notify the update timing to the manager of the management server 40.

In the above-described embodiment, an example has been shown in which the first charger 10 includes the processor 11 and the storage device 12, but the present disclosure is not limited thereto. For example, the functions of the processor 11 and the storage device 12 of the first charger 10 may be implemented on the cloud. The same applies to the application server 30, the management server 40, and the information input terminal 50.

In the above-described embodiment, an example has been shown in which the first charger 10 is driven based on the first charger information 15 stored in the storage device 12, but the present disclosure is not limited thereto. The first charger 10 may be driven based on the first charger information 15 stored in the management server 40 by requesting the management server 40 to transmit the first charger information 15 each time the first charger 10 is driven.

The embodiment disclosed herein is to be considered merely illustrative and not restrictive in all respects. The scope of the present disclosure is indicated by the scope of claims rather than by the description of the above-described embodiment, and is intended to include all modifications within the scope and meaning equivalent to the scope of the claims.

What is claimed is:

1. A management system comprising:
a communication terminal;
a charger configured to operate based on charger information; and
an application server configured to store total charger information, wherein:
the communication terminal includes a display unit configured to display the total charger information acquired from the application server;
the total charger information includes charger correspondence information corresponding to the charger information; and
the charger information is updated at an update timing that is a timing when the application server updates the charger correspondence information.

2. The management system according to claim 1, wherein:
the charger stores the charger information; and
the charger updates the charger information at the update timing.

3. The management system according to claim 1, further comprising a management server configured to manage the charger, wherein:
the management server transmits change information that is a part of the charger information to the charger at the update timing; and
the charger stores the charger information and updates the charger information based on the change information.

4. The management system according to claim 1, further comprising:
an information input terminal; and
a management server configured to manage the charger, wherein:
the information input terminal transmits change information that is a part of the charger information to the management server at the update timing;
the management server transmits the change information to the charger; and
the charger stores the charger information and updates the charger information based on the change information.

5. The management system according to claim 1, further comprising:
an information input terminal;
a management server configured to manage the charger; and
a manager terminal used by a manager of the management server, wherein:
the manager terminal notifies the manager of the update timing;
the information input terminal transmits, to the management server, change information that is a part of the charger information and is input by the manager to the information input terminal;
the management server transmits the change information to the charger; and
the charger stores the charger information and updates the charger information based on the change information.
